(19) United States
(12) Patent Application Publication
(10) Pub. No.: US 2022/0006199 A1
(43) Pub. Date: Jan. 6, 2022

(54) METAMATERIAL LOADED ANTENNAS

(71) Applicants: Amir Jafargholi, Tehran (IR); Seyed Saleh Mousavi Khaleghi, Tehran (IR); Kamyar Goudarzi, Tehran (IR); Mehran Ahadi, Tehran (IR); Parviz Parvin, Tehran (IR)

(72) Inventors: Amir Jafargholi, Tehran (IR); Seyed Saleh Mousavi Khaleghi, Tehran (IR); Kamyar Goudarzi, Tehran (IR); Mehran Ahadi, Tehran (IR); Parviz Parvin, Tehran (IR)

(73) Assignees: Amir Jafargholi, Tehran (IR); Parviz Parvin, Tehran (IR); Amirkabir University of Technology, Tehran (IR)

(21) Appl. No.: 17/478,963

(22) Filed: Sep. 20, 2021

Related U.S. Application Data
(60) Provisional application No. 63/081,936, filed on Sep. 23, 2020.

(51) Int. Cl. H01Q 15/00

(52) U.S. Cl. CPC H01Q 15/0086

(57) ABSTRACT

A metamaterial loaded antenna. The metamaterial loaded antenna includes a dielectric substrate, a first arm, a second arm, a feed point, and a metamaterial structure. The first arm and the second arm are placed on the dielectric substrate. The feed point includes at least one gap between the first arm and the second arm. A metamaterial structure is inserted in the feed point. The metamaterial structure includes a single negative (SNG) metamaterial. The SNG metamaterial includes a first permittivity ϵ₁ and a first permeability μ₁. The first permittivity ϵ₁ and the first permeability μ₁ satisfy a condition according to ϵ₁μ₁<0.

### CROSS-REFERENCE TO RELATED APPLICATION

This application claims the benefit of priority from pending U.S. Provisional Patent Application Ser. No. 63/081,936, filed on Sep. 23, 2020, and entitled “METAMATERIAL LOADED ANTENNA,” which is incorporated herein by reference in its entirety.

### TECHNICAL FIELD

The present disclosure generally relates to antennas, and particularly, to metamaterial based antennas.

### BACKGROUND

Photovoltaic cells are one of the important achievements of quantum physics in the application of solar energy harvesting. However, one of the challenges in this technology is low efficiency, in addition to a high cost of implementing high efficiency photovoltaic panels. Several approaches have been proposed to enhance and improve the efficiency of conventional solar cells, ranging from utilizing nanoparticles, nanotubes, and nanostructures to innovating new composite materials. But a main issue related to these methods is a theoretical limitation of photovoltaic technology.

According to the principles of photovoltaic technology, the efficiency of a cell is a function of the forbidden band of the semiconductor material. In semiconductor materials, an electron that is excited by receiving enough energy level passes through this forbidden band, and results in an electric current. Theoretically, this phenomenon confines the efficiency of single-junction cells up to 30% and multi junction cells to 55%. Other issues related to use of this technology are due to the nature of light particles (photons). For example, a solar panel may have to be aligned with the sunlight direction to maximize the number of colliding photons with the surface of the semiconductor material. Furthermore, the surface of the solar panel may have additional loss which may considerably reduce the efficiency.

Among the solutions proposed to improve efficiency of solar energy harvesting, rectennas are among options to be considered. A rectenna is defined as a combination of an antenna and a rectifier. In contrast to the particle theory of light which is based on quantum physics, rectennas work based on the wave theory of light. In other words, similar to lower frequencies such as microwave band and millimeter waves, a rectenna is utilized as a transducer to convert received electromagnetic waves to an alternating voltage and an electric current (AC) in visible and infrared bands. An existing challenge of rectennas is the need for an efficient high-frequency rectifier to convert this AC current to a direct current (DC). At lower frequencies, diodes are usually employed as rectifiers due to nonlinear characteristics of diodes. However, in the range of optical frequencies, technological limits may have to be overcome to obtain efficient rectifiers. Unlike photovoltaic technology, the efficiency of rectennas theoretically can reach up to 100%. However, at present, due to limitations in the design of efficient optical rectifiers, there is a large gap between the estimated efficiency of rectennas and what is obtained in empirical observations.

There is, therefore, a need for a method that may increase the efficiency of converting electromagnetic and optical radiations to DC signals. There is also a need for an antenna structure that may absorb and convert optical radiations to DC signals with a high efficiency.

### SUMMARY

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

In one general aspect, the present disclosure describes an exemplary metamaterial loaded antenna. An exemplary metamaterial loaded antenna may include a dielectric substrate, a first arm, a second arm, a feed point, and a metamaterial structure. In an exemplary embodiment, the first arm and the second arm may be placed on the dielectric substrate. An exemplary feed point may include at least one gap between the first arm and the second arm. An exemplary metamaterial structure may be inserted in the feed point. In an exemplary embodiment, the metamaterial structure may include a single negative (SNG) metamaterial. An exemplary SNG metamaterial may include a first permittivity ϵ₁ and a first permeability In an exemplary embodiment, first permittivity ϵ₁ and first permeability μ₁ may satisfy a condition according to ϵ₁μ₁<0.

In an exemplary embodiment, the first arm and the second arm may include a conductive material and may be configured to absorb optical waves emitted from a radiation source to each respective top surface of the first arm and the second arm and convert the optical waves to an electric field at the feed point. An exemplary conductive material may be made of gold.

In an exemplary embodiment, each respective top surface of each of the first arm and the second arm may be exposed to the optical waves that may be emitted from the radiation source. In an exemplary embodiment, each respective top surface of each of the first arm and the second arm may include a two-dimensional shape that may be enclosed within a boundary and may encompass all of a respective space within the boundary. An exemplary boundary may include a first straight line, a second straight line, a third straight line, a first curved line, and a second curved line. An exemplary second straight line may be perpendicular to the first straight line. In an exemplary embodiment, a first end of the second straight line may coincide with a first end of the first straight line. An exemplary third straight line may be parallel with and equal in length to the second straight line. In an exemplary embodiment, a first end of the third straight line may coincide with a second end of the first straight line. An exemplary first curved line may include a first circular arc. In an exemplary embodiment, a concave side of the first circular arc may face the second straight line. In an exemplary embodiment, a first end of the first curved line may coincide with a second end of the second straight line and a second end of the first curved line may be located in a middle of a distance between the second straight line and the third straight line. An exemplary second curved line may include a second circular arc. In an exemplary embodiment, a concave side of the second circular arc may face the third straight line. In an exemplary embodiment, a first end of the second curved line may coincide with a second end of the third straight line and a second end of the second curved line may coincide with the second end of the first curved line.

An exemplary metamaterial structure may further include an epsilon-and-mu-near-zero (EMNZ) metamaterial that may be inserted between two portions of the SNG metamaterial. An exemplary EMNZ metamaterial may include a second permittivity ϵ₂ and a second permeability μ₂. In an exemplary embodiment, second permittivity ϵ₂ and the second permeability μ₂ may satisfy a set of conditions according to ϵ₂<0.1 ϵ₀ and μ₂<0.1 μ₀ where ϵ₀ is the vacuum permittivity and μ₀ is the vacuum permeability.

In an exemplary embodiment, the two portions of the SNG metamaterial may include a first portion and a second portion. A width of an exemplary first portion may be equal to a width of an exemplary second portion. In an exemplary embodiment, a width W_{EMNZ} of the EMNZ metamaterial may be smaller than W_{MTM}/2 where W_{MTM} is a width of the metamaterial structure.

Other exemplary systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the claims herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 shows a flowchart of a method for increasing an electric field concentration in an antenna, consistent with one or more exemplary embodiments of the present disclosure.

FIG. 2A shows a schematic of a metamaterial loaded antenna, consistent with one or more exemplary embodiments of the present disclosure.

FIG. 2B shows a schematic of a top view of a metamaterial loaded antenna, consistent with one or more exemplary embodiments of the present disclosure.

FIG. 2C shows a schematic of a top surface of an arm of a metamaterial loaded antenna, consistent with one or more exemplary embodiments of the present disclosure.

FIG. 2D shows a schematic of a side view of a first implementation of a metamaterial loaded antenna, consistent with one or more exemplary embodiments of the present disclosure.

FIG. 2E shows a schematic of a side view of a second implementation of a metamaterial loaded antenna, consistent with one or more exemplary embodiments of the present disclosure.

FIG. 3A shows ratios of electric field magnitudes at a feed point of unloaded antennas to electric field magnitudes at a feed point of single negative (SNG) metamaterial loaded antennas with different permittivity values, consistent with one or more exemplary embodiments of the present disclosure.

FIG. 3B shows electric field magnitudes at a feed point of an unloaded antenna and an SNG metamaterial loaded antenna, consistent with one or more exemplary embodiments of the present disclosure.

FIG. 4A shows a distribution of an electric field at a feed point of an unloaded antenna at different frequencies, consistent with one or more exemplary embodiments of the present disclosure.

FIG. 4B shows a distribution of an electric field at a feed point of an SNG metamaterial loaded antenna at different frequencies, consistent with one or more exemplary embodiments of the present disclosure.

FIG. 5 shows electric field magnitudes at a feed point of a single layer metamaterial loaded antenna and a multilayer metamaterial loaded antenna, consistent with one or more exemplary embodiments of the present disclosure.

FIG. 6 shows a distribution of an electric field at a feed point of a multilayer metamaterial loaded antenna at different frequencies, consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Herein is disclosed an exemplary method and structure for enhancing concentration of electromagnetic fields at a feed point (i.e., a region in which electric power is delivered) of an exemplary antenna. A higher electric field strength may lead to a more efficient rectification of AC voltages and electric currents to DC ones. To obtain a higher concentration of the electric field at the feed point, an exemplary metamaterial structure may be inserted in a feed point of an exemplary antenna. An exemplary metamaterial structure may include a single negative (SNG) metamaterial that may have a negative permittivity or permeability. An exemplary metamaterial structure may further include an epsilon-mu-near-zero (EMNZ) metamaterial (i.e., a metamaterial with near zero values of permittivity and permeability) that is sandwiched between two portions of the SNG metamaterial. As a result, the electric field concentration at an exemplary antenna feed point may be further enhanced.

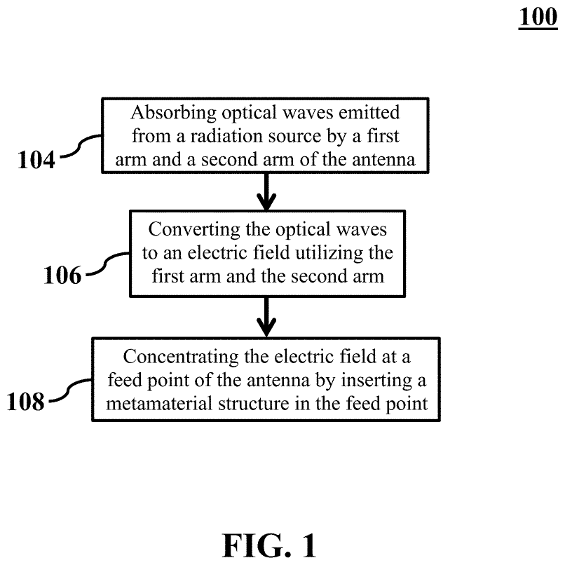

FIG. 1 shows a flowchart of a method for increasing an electric field concentration in an antenna, consistent with one or more exemplary embodiments of the present disclosure. An exemplary method 100 may include absorbing optical waves that may be emitted from a radiation source by a first arm of the antenna and the second arm of the antenna (step 104), converting the optical waves to an electric field utilizing the first arm and the second arm (step 106), and concentrating the electric field at a feed point of the antenna by inserting a metamaterial structure in the feed point (step 108). In an exemplary embodiment, the first arm and the second arm may include conductive materials and may be placed on a dielectric substrate of the antenna.

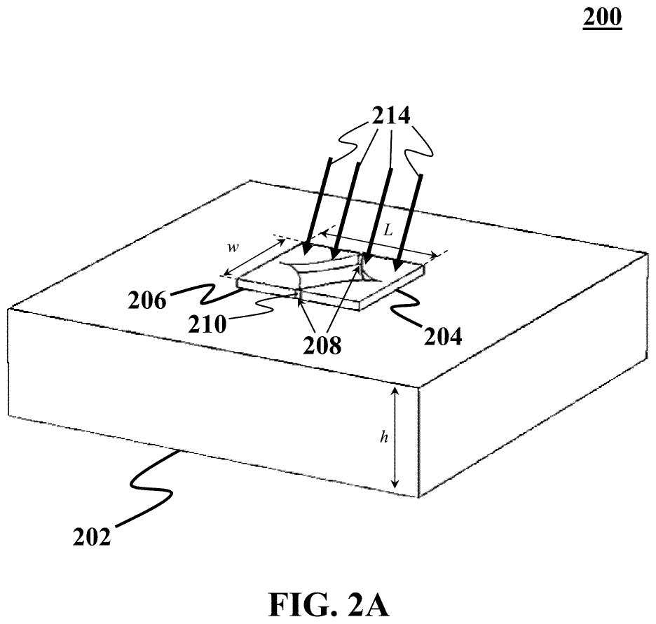

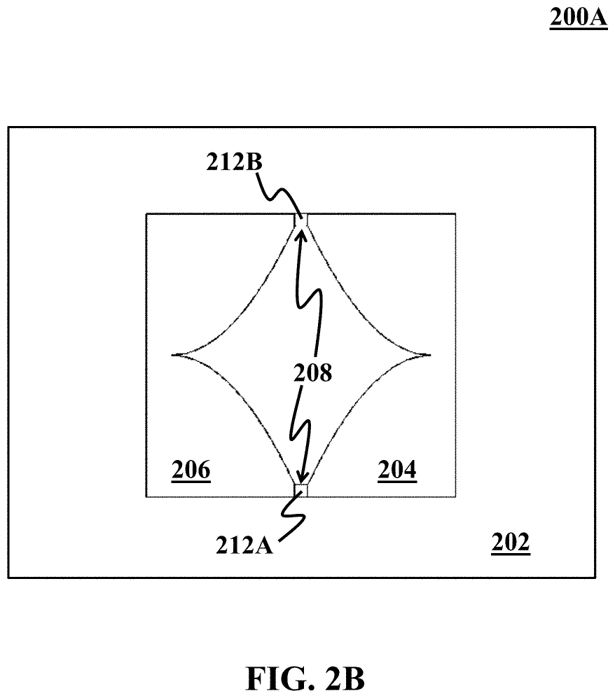

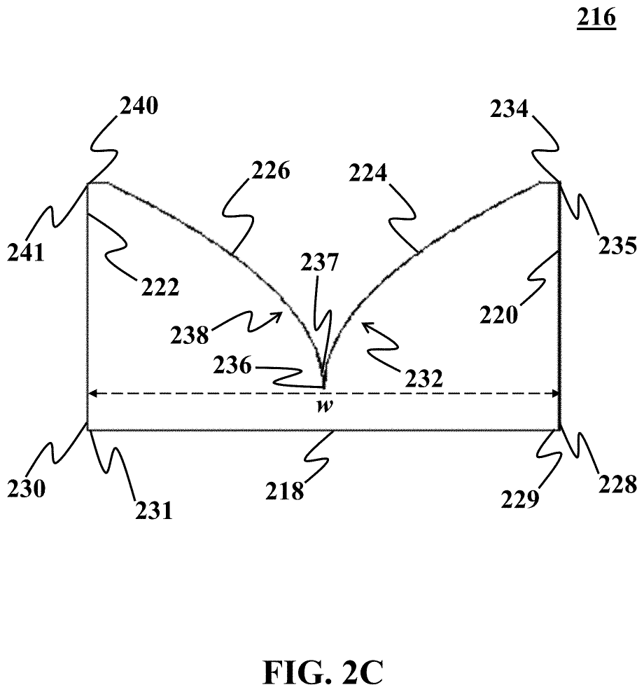

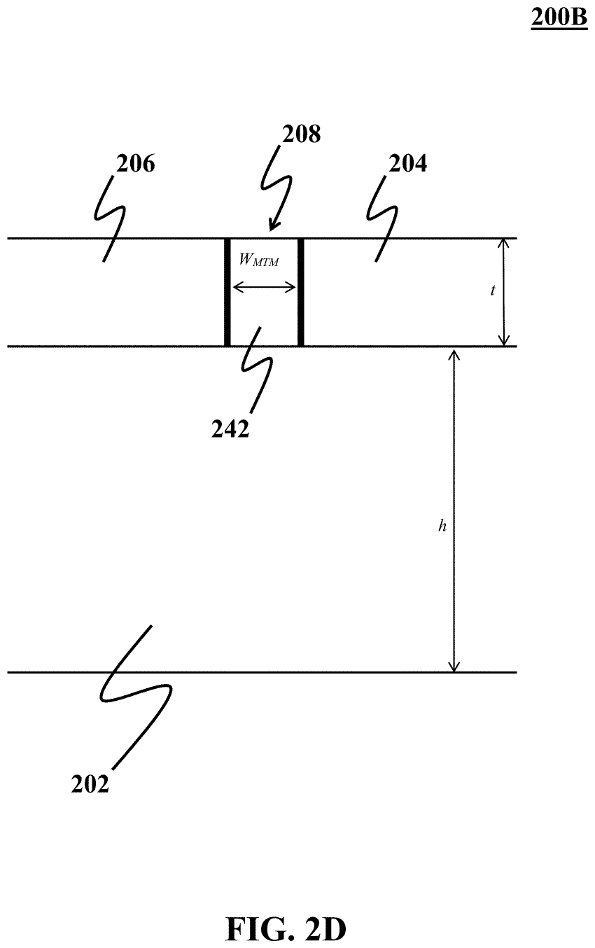

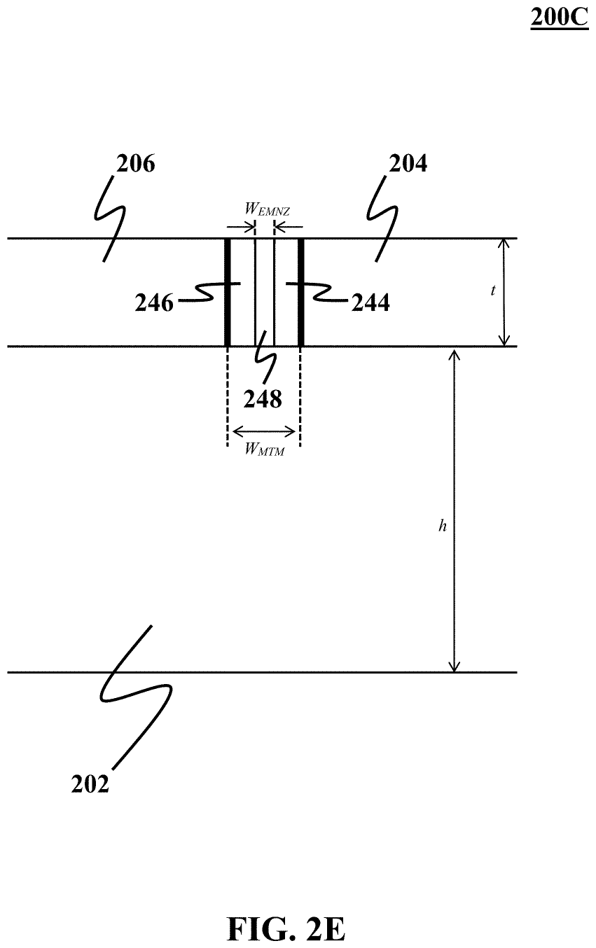

FIG. 2A shows a schematic of a metamaterial loaded antenna, consistent with one or more exemplary embodiments of the present disclosure. In an exemplary embodiment, different steps of method 100 may be implemented utilizing an exemplary metamaterial loaded antenna 200. In an exemplary embodiment, metamaterial loaded antenna 200 may include a dielectric substrate 202, a first arm 204, a second arm 206, a feed point 208, and a metamaterial structure 210.

In an exemplary embodiment, metamaterial loaded antenna 200 may include different types of antenna structures, including dipole, spiral, or bowtie structures. In an exemplary embodiment, different antenna structures may be utilized in metamaterial loaded antenna 200 to implement a rectenna, i.e., a combination of an antenna and a rectifier. In contrast to the particle theory of light which is based on quantum physics, an exemplary rectenna may work based on the wave theory of light. In other words, similar to lower frequencies such as microwave band and millimeter waves, a rectenna may be utilized as a transducer to convert received electromagnetic waves to a voltage and an electric current in visible and infrared bands.

FIG. 2B shows a schematic of a top view of a metamaterial loaded antenna, consistent with one or more exemplary embodiments of the present disclosure. Top view of metamaterial loaded antenna 200A may by similar to a top view of metamaterial loaded antenna 200. In an exemplary embodiment, first arm 204 and second arm 206 may be mounted on dielectric substrate 202. In an exemplary embodiment, feed point 208 may include at least one gap between first arm 204 and second arm 206. In an exemplary embodiment, there may be more than one gap, such as gaps 212A and 212B between first arm 204 and second arm 206.

Referring again to FIGS. 1 and 2A, in an exemplary embodiment, step 104 may include absorbing optical waves 214 that may be emitted from a radiation source by first arm 204 and second arm 206. An exemplary radiation source may include a natural source such as the sun or an artificial source such as a lamp. In an exemplary embodiment, each of first arm 204 and second arm 206 may include a conductive material for absorbing optical radiations. An exemplary conductive material may be made of gold.

In an exemplary embodiment, optical waves 214 may be absorbed by top surfaces of first arm 204 and second arm 206. FIG. 2C shows a schematic of a top surface of an arm of a metamaterial loaded antenna, consistent with one or more exemplary embodiments of the present disclosure. Referring to FIGS. 2B and 2C, an exemplary surface 216 may refer to each respective top surface of each of first arm 204 or second arm 206. An exemplary top surface may refer to a respective surface of each of first arm 204 or second arm 206 that may be exposed to optical waves 214 In an exemplary embodiment, surface 216 may include a two-dimensional shape that may be enclosed within a boundary and encompassing all the area within that boundary. An exemplary boundary may include a first straight line 218, a second straight line 220, a third straight line 222, a first curved line 224, and a second curved line 226.

In an exemplary embodiment, second straight line 220 may be perpendicular to first straight line 218. An exemplary first end 228 of second straight line 220 may coincide with an exemplary first end 229 of first straight line 218. In an exemplary embodiment, third straight line 222 may be parallel with and equal in length to second straight line 220. An exemplary first end 230 of third straight line 222 may coincide with an exemplary second end 231 of first straight line 218. In an exemplary embodiment, first curved line 224 may include a first circular arc. An exemplary concave side 232 of the first circular arc may face second straight line 220. An exemplary first end 234 of first curved line 224 may coincide with an exemplary second end 235 of second straight line 220. An exemplary second end 236 of first curved line 224 may be located in a middle of a distance w between second straight line 220 and third straight line 222. In an exemplary embodiment, second curved line 226 may include a second circular arc. An exemplary concave side 238 of the second circular arc may face third straight line 222. An exemplary first end 240 of second curved line 226 may coincide with an exemplary second end 241 of third straight line 222. In an exemplary embodiment, a second end 237 of second curved line 226 may coincide with second end 236 of first curved line 224.

Referring again to FIGS. 1 and 2A, in an exemplary embodiment, step 106 may include converting optical waves 214 to an electric field utilizing first arm 204 and second arm 206. In an exemplary embodiment, after being absorbed by first arm 204 and/or second arm 206, optical waves 214 may cause electrons in metamaterial loaded antenna 200 to move back and forth at a same frequency as optical waves 214. Exemplarily moving electrons may generate an electric field in metamaterial loaded antenna 200, resulting an alternating current (AC) in feed point 208. In an exemplary embodiment, a diode may be coupled to metamaterial loaded antenna 200 to rectify generated AC signals to obtain a rectified direct current (DC) at feed point 208 from optical waves 214. As a result, in an exemplary embodiment, metamaterial loaded antenna 200 may be utilized to implement an optical rectenna.

In an exemplary embodiment, an overall efficiency of metamaterial loaded antenna 200 may consist of three parts. A first part of the efficiency may be related to an amount of light absorbed by metamaterial loaded antenna 200 in step 104. This efficiency may be similar to a traditional radiation efficiency of antennas and may describe a conversion rate of input power of optical waves 214 to voltage and electric current at feed point 208, η^{rad}. A second part may describe conversion of absorbed light to a DC electrical power by an exemplary rectifier through step 106. A third part may be defined by a power loss due to a mismatch between an antenna impedance and an exemplary rectifier.

In an exemplary embodiment, coupling optical waves 214 into metamaterial loaded antenna 200 may be similar to a coupling in lower frequencies, e.g., microwave bands. An exemplary radiation efficiency of metamaterial loaded antenna 200 may be defined according to the following:

$${η}^{r a d} = \frac{{p}^{rad}}{{p}^{inject}} = \frac{{p}^{rad}}{{p}^{rad} + {p}^{l o s s}} \qquad Equation ( 1 )$$

where p^{inject} indicates an incident power, p^{loss} is a lost power and p^{rad} is an amount of power that is converted to voltage and electric current at feed point 208.

In an exemplary embodiment, an overall efficiency of metamaterial loaded antenna 200 may be defined by the following:

$${η}^{tot} = \frac{{\int }_{0}^{∞} ρ ( λ , T ) {η}^{rad} ( λ ) d λ}{{\int }_{0}^{∞} p ( λ , T ) d λ} \qquad Equation ( 2 )$$

where λ is the wavelength, and p(λ, T) is a blackbody radiation according to the Planck's law and is given by the following:

$$p ( λ , T ) = \frac{2 π h {c}^{2}}{{λ}^{5}} \frac{1}{{e}^{\frac{h c}{λ KT} - 1}} \qquad Equation ( 3 )$$

where T is the body temperature in Kelvin, h is the Planck constant [h=6.626×10⁻³⁴ (J/K)], c is the speed of light in a vacuum, and K is the Boltzmann constant.

According to Equations (1)-(3), in an exemplary embodiment, increasing the conversion rate of radiated waves to electric signals and reducing the power loss in metamaterial loaded antenna 200 may increase overall efficiency η^{tot}. In an exemplary embodiment, a metamaterial structure may be used to improve overall efficiency η^{tot} by increasing surface plasmons and compensating for electric field drops that may occur due to a high existent attenuation in feed point 208. An exemplary metamaterial structure (that may include a metal with periodic grooves inside) may increase concentration of the electric field in feed point 208 (i.e., local electric field) by increasing surface plasmons in the gaps between first arm 204 and second arm 206. In an exemplary embodiment, increasing the concentration of local fields in the gaps may increase energy levels of received photons at the antenna surface which may lead to a higher absorption rate of received photons at the antenna surface. Therefore, the total efficiency may improve.

For further detail regarding step 108, FIG. 2D shows a schematic of a side view of a first implementation of a metamaterial loaded antenna, consistent with one or more exemplary embodiments of the present disclosure. Side view of metamaterial loaded antenna 200B may be similar to a side view of a first implementation of metamaterial loaded antenna 200. In an exemplary embodiment, concentrating the electric field at feed point 208 in step 108 may include inserting a metamaterial structure 242 in feed point 208. In an exemplary embodiment, metamaterial structure 242 may include a single layer structure. An exemplary single layer structure may consist of a single negative (SNG) metamaterial. An exemplary SNG metamaterial may include a first permittivity ϵ₁ and a first permeability μ₁. In an exemplary embodiment, first permittivity ϵ₁ and first permeability μ₁ may satisfy a condition according to ϵ₁μ₁<0. In other word, one and only one of first permittivity ϵ₁ and first permeability μ₁ of an exemplary SNG metamaterial may be negative.

In order to realize an exemplary SNG metamaterial, several exemplary structures may be utilized that include periodic structures, e.g., split-ring resonator (SRR) layered structures (i.e., two materials with different signs of electric permittivity or different filling coefficients). Moreover, there are various mixtures, e.g., titanium hydrides (TiHx) with various coefficients, which may have a suitable electric permittivity through a desired frequency bandwidth.

FIG. 2E shows a schematic of a side view of a second implementation of a metamaterial loaded antenna, consistent with one or more exemplary embodiments of the present disclosure. Metamaterial loaded antenna 200C may include a side view of a second implementation of metamaterial loaded antenna 200. In an exemplary embodiment, metamaterial structure 242 may further include an epsilon-and-mu-near-zero (EMNZ) metamaterial that may be inserted between two portions of the SNG metamaterial. An exemplary EMNZ metamaterial may include a second permittivity ϵ₂ and a second permeability μ₂. In an exemplary embodiment, values of second permittivity ϵ₂ and the second permeability μ₂ may be “near zero.” In an exemplary embodiment, near zero values of second permittivity ϵ₂ and a second permeability μ₂ may refer to values that may satisfy a set of conditions according to ϵ₂<0.1ϵ₀ and μ₂<0.1μ₀ where ϵ₀ is the vacuum permittivity and μ₀ is the vacuum permeability. In other words, in an exemplary embodiment, second permittivity ϵ₂ and the second permeability μ₂ may be significantly smaller than the vacuum permittivity and the vacuum permeability, respectively.

In an exemplary embodiment, the two portions of the SNG metamaterial may include a first portion 244 and a second portion 246. As a result, an exemplary multilayer structure may be obtained that may include an EMNZ metamaterial 248 between first portion 244 and second portion 246 of the SNG metamaterial. In an exemplary embodiment, a width W_{EMNZ} of EMNZ metamaterial 248 may be smaller than W_{MTM}/2 where W_{MTM} is a width of metamaterial structure 242.

In an exemplary embodiment, EMNZ metamaterial 248 may be realized with various techniques, including periodic structures, e.g., wire media layered structures (i.e., two materials with different signs of electric permittivity or different filling coefficients), a waveguide at a cutoff frequency, and other possible methods. Moreover, there may be various exemplary mixtures, such as indium tin oxide (ITO) and other available composites that may have a suitable electric permittivity through an entire frequency band (i.e., near zero permittivity and permeability).

### EXAMPLE 1

In this example, the performance of an exemplary antenna loaded with a single layer SNG metamaterial is demonstrated. An exemplary antenna has a bowtie structure (similar to metamaterial loaded antenna 200 in FIG. 2A) which is mounted on a quartz substrate (similar to dielectric substrate 202) with a relative permittivity of about 3.75. Exemplary arms (similar to first arm 204 and second arm 206) of the bowtie structure arc made of gold. Numerical values of exemplary design parameters (analogues to parameters shown in FIGS. 2A and 2D) are presented in Tables 1 and 2. In these tables, two antennas for two frequency ranges of about 100-400 THz and 400-800 THz are presented.

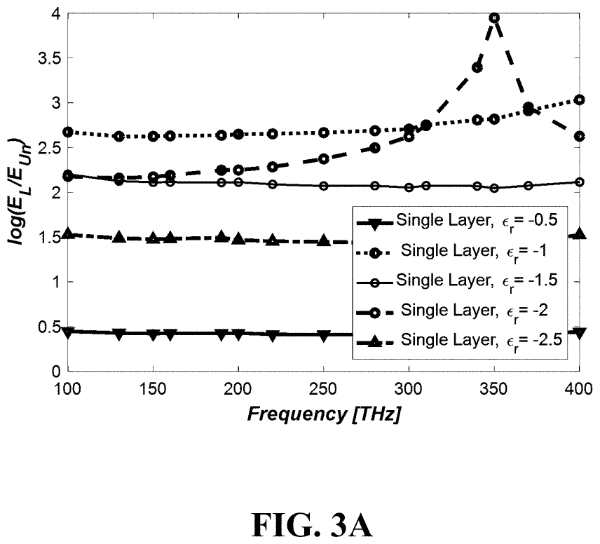

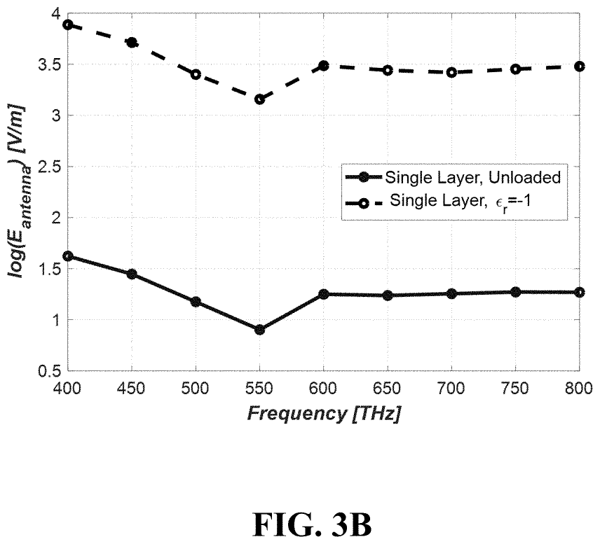

FIG. 3A shows ratios of electric field magnitudes at a feed point of unloaded antennas to electric field magnitudes at a feed point of SNG metamaterial loaded antennas with different permittivity values, consistent with one or more exemplary embodiments of the present disclosure. FIG. 3B shows electric field magnitudes at a feed point of an unloaded antenna and an SNG metamaterial loaded antenna, consistent with one or more exemplary embodiments of the present disclosure. Referring to FIGS. 3A and 3B, the electric field strength may increase significantly in the presence of SNG metamaterials.

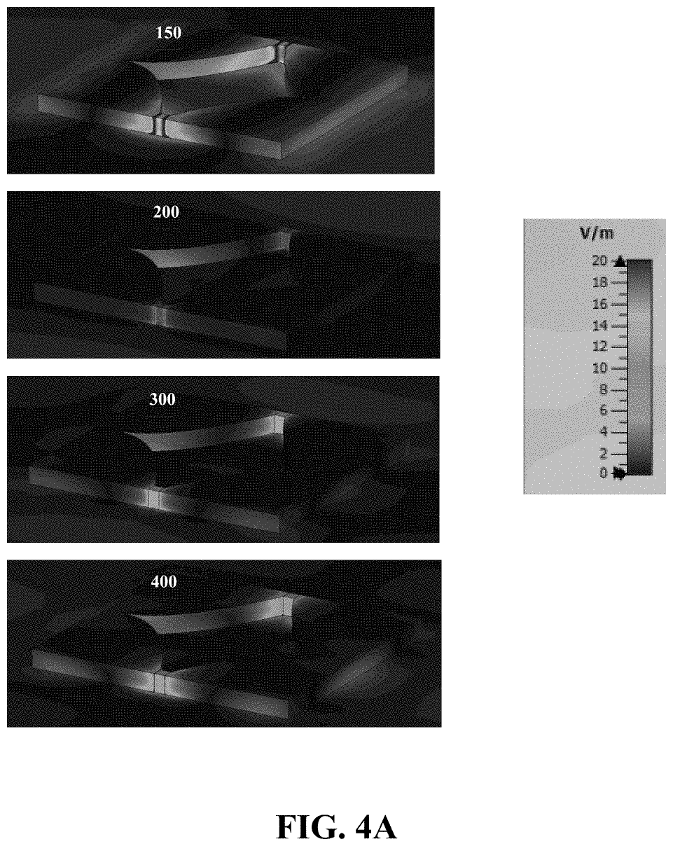

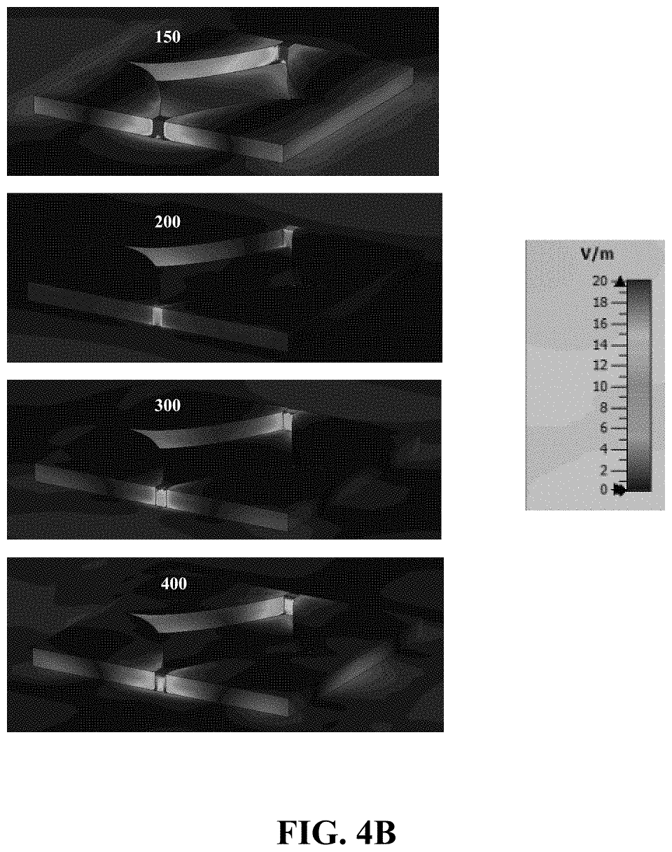

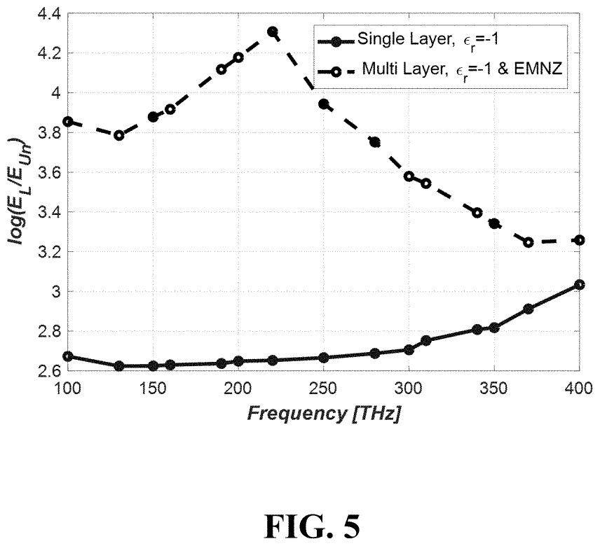

FIG. 4A shows a distribution of an electric field at a feed point of an unloaded antenna at different frequencies, consistent with one or more exemplary embodiments of the present disclosure. FIG. 4B shows a distribution of an electric field at a feed point of an SNG metamaterial loaded antenna at different frequencies, consistent with one or more exemplary embodiments of the present disclosure. The distribution of the electric field in the antenna feed point for unloaded and SNG metamaterial loaded antennas at the frequencies of f=150, f=200, f=300, and f=400 THz are compared in FIGS. 5A and 5B. It may be observed in the figures that in an SNG metamaterial loaded antenna, the electric field strength is much higher than the electric field strength in the unloaded antenna.

TABLE 1
Dimensions of an antenna loaded with a single-layer metamaterial
that works at a frequency range of 100-400 THz, all dimensions
are in nm.

| | |
|---|---|
| L | 600 |
| W | 550 |
| W_{MTM} | 25 |
| T | 40 |
| H | 500 |

TABLE 2
Dimensions of an antenna loaded with a single-layer metamaterial
that works at a frequency range of 400-800 THz, all dimensions
are in nm.

| | |
|---|---|
| L | 205 |
| W | 225 |
| W_{MTM} | 9 |
| t | 40 |
| h | 185 |

### EXAMPLE 2

In this example, the performance of an exemplary antenna loaded with a multilayer structure consisting of an EMNZ layer sandwiched by two SNG materials is demonstrated. An exemplary antenna has a bowtie structure (similar to metamaterial loaded antenna 200 in FIG. 2A) which is mounted on a quartz substrate (similar to dielectric substrate 202) with a relative permittivity of about 3.75. Exemplary arms (similar to first arm 204 and second arm 206) of the bowtie structure are made of gold. Numerical values of exemplary design parameters (analogues to parameters shown in FIGS. 2A and 2E) are presented in Table 3.

FIG. 5 shows electric field magnitudes at a feed point of a single layer metamaterial loaded antenna and a multilayer metamaterial loaded antenna, consistent with one or more exemplary embodiments of the present disclosure. It may be observed in the figure that the electric field strength increases dramatically in the presence of the multilayer metamaterial.

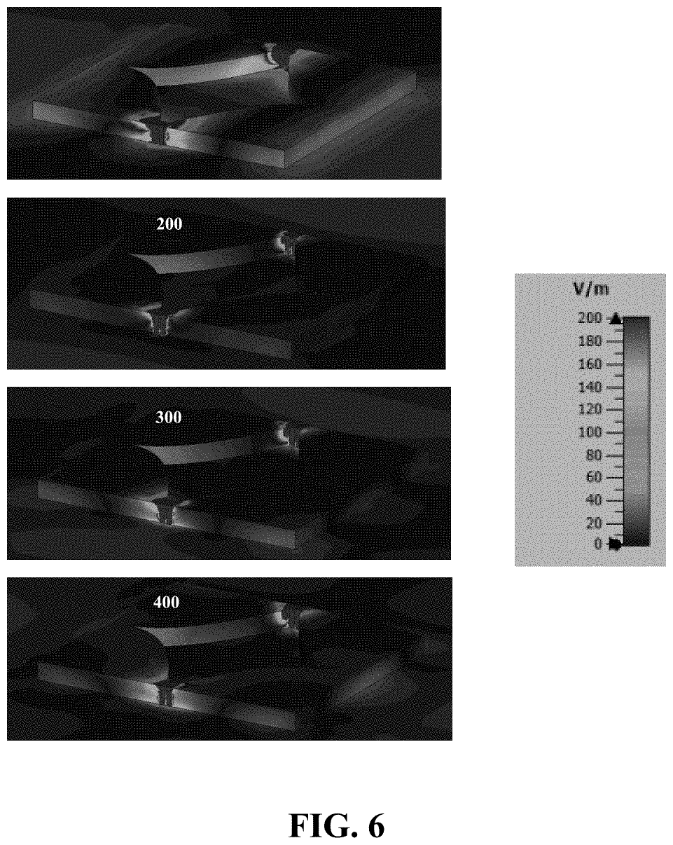

FIG. 6 shows a distribution of an electric field at a feed point of a multilayer metamaterial loaded antenna at different frequencies, consistent with one or more exemplary embodiments of the present disclosure. The electric field distributions in the antenna feed point for the multilayer metamaterial loaded antenna at the frequencies of f=150, f=200, f =300, and f=400 THz arc in FIG. 6. By comparing FIG. 6 with FIGS. 4A and 4B it may be observed the electric field strength in the multilayer antenna is much higher than the electric field strength in the unloaded and single layer antennas.

TABLE 3
Dimensions of an antenna loaded with a multilayer metamaterial
that works at a frequency range of 100-400 THz, all dimensions
are in nm.

| | |
|---|---|
| L | 600 |
| W | 550 |
| W_{MTM} | 25 |
| W_{EMNZ} | 5 |
| t | 40 |
| h | 500 |

While the foregoing has described what may be considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A metamaterial loaded antenna, comprising:
a dielectric substrate;
a first arm made of gold and placed on the dielectric substrate;
a second arm made of gold and placed on the dielectric substrate;
a feed point comprising at least one gap between the first arm and the second arm; and
a metamaterial structure inserted in the feed point, the metamaterial structure comprising:
a single negative (SNG) metamaterial comprising a first portion and a second portion wherein a width of the first portion is equal to a width of the second portion, the SNG metamaterial comprising a first permittivity ϵ₁ and a first permeability μ₁, the first permittivity ϵ₁ and the first permeability μ₁ satisfying a condition according to ϵ₁μ₁<0; and
an epsilon-and-mu-near-zero (EMNZ) metamaterial inserted between the first portion and the second portion, the EMNZ metamaterial comprising a second permittivity ϵ₂ and a second permeability μ₂, wherein:
the second permittivity ϵ₂ and the second permeability μ₂ satisfy a set of conditions according to ϵ₂<0.1μ₀ and μ₂<0.1μ₀ where ϵ₀ is the vacuum permittivity and μ₀ is the vacuum permeability; and
a width W_{EMNZ} of the EMNZ metamaterial is smaller than W_{MTM}/2 where W_{MTM} is a width of the metamaterial structure,
wherein:
the first arm and the second arm are configured to:
absorb optical waves emitted from a radiation source to each respective top surface of the first arm and the second arm; and
convert the optical waves to an electric field at the feed point; and
a respective top surface of each of the first arm and the second arm is exposed to the optical waves and comprises a two-dimensional shape enclosed within a boundary and encompasses all of a respective space within the boundary, the boundary comprising:
a first straight line;
a second straight line perpendicular to the first straight line, a first end of the second straight line coinciding with a first end of the first straight line;
a third straight line parallel with and equal in length to the second straight line, a first end of the third straight line coinciding with a second end of the first straight line;
a first curved line comprising a first circular arc, a concave side of the first circular arc facing the second straight line, a first end of the first curved line coinciding with a second end of the second straight line and a second end of the first curved line located in a middle of a distance between the second straight line and the third straight line; and
a second curved line comprising a second circular arc, a concave side of the second circular arc facing the third straight line, a first end of the second curved line coinciding with a second end of the third straight line and a second end of the second curved line coinciding with the second end of the first curved line.

2. A metamaterial loaded antenna, comprising:
a dielectric substrate;
a first arm placed on the dielectric substrate;
a second placed on the dielectric substrate;
a feed point comprising at least one gap between the first arm and the second arm; and
a metamaterial structure inserted in the feed point, the metamaterial structure comprising a single negative (SNG) metamaterial, the SNG metamaterial comprising a first permittivity ϵ₁ and a first permeability μ₁, the first permittivity ϵ₁ and the first permeability μ₁ satisfying a condition according to ϵ₁μ₁<0.

3. The metamaterial loaded antenna of claim 2, wherein the metamaterial structure further comprises an epsilon-and-mu-near-zero (EMNZ) metamaterial inserted between two portions of the SNG metamaterial, the EMNZ metamaterial comprising a second permittivity ϵ₂ and a second permeability μ₂, wherein the second permittivity ϵ₂ and the second permeability μ₂ satisfy a set of conditions according to ϵ₂<0.1μ₀ and μ₂<0.1μ₀ where ϵ₀ is the vacuum permittivity and μ₀ is the vacuum permeability.

4. The metamaterial loaded antenna of claim 3, wherein the two portions of the SNG metamaterial comprise a first portion and a second portion, a width of the first portion equal to a width of the second portion.

5. The metamaterial loaded antenna of claim 3, wherein a width W_{EMNZ} of the EMNZ metamaterial is smaller than W_{MTM}/2 where W_{MTM} is a width of the metamaterial structure.

6. The metamaterial loaded antenna of claim 2, wherein a respective top surface of each of the first arm and the second arm is exposed to optical waves emitted from a radiation source, comprises a two-dimensional shape enclosed within a boundary, and encompasses all of a respective space within the boundary, the boundary comprising:
a first straight line;
a second straight line perpendicular to the first straight line, a first end of the second straight line coinciding with a first end of the first straight line;
a third straight line parallel with and equal in length to the second straight line, a first end of the third straight line coinciding with a second end of the first straight line;
a first curved line comprising a first circular arc, a concave side of the first circular arc facing the second straight line, a first end of the first curved line coinciding with a second end of the second straight line and a second end of the first curved line located in a middle of a distance between the second straight line and the third straight line; and
a second curved line comprising a second circular arc, a concave side of the second circular arc facing the third straight line, a first end of the second curved line coinciding with a second end of the third straight line and a second end of the second curved line coinciding with the second end of the first curved line.

7. The metamaterial loaded antenna of claim 6, wherein the first arm and the second arm comprise a conductive material and are configured to:
absorb the optical waves emitted from the radiation source to each respective top surface of the first arm and the second arm; and
convert the optical waves to an electric field at the feed point.

8. The metamaterial loaded antenna of claim 7, wherein the conductive material is made of gold.

9. A method for increasing an electric field concentration in an antenna, the method comprising:
absorbing optical waves emitted from a radiation source by a first arm of the antenna and a second arm of the antenna, the first arm and the second arm placed on a dielectric substrate of the antenna;
converting the optical waves to an electric field utilizing the first arm and the second arm; and
concentrating the electric field at a feed point of the antenna by inserting a metamaterial structure in the feed point, the feed point comprising at least one gap between the first arm and the second arm,
wherein the metamaterial structure comprises a single negative (SNG) metamaterial, the SNG metamaterial comprising a first permittivity Ε₁ and a first permeability μ₁, the first permittivity ϵ₁ and the first permeability μ₁ satisfying a condition according to ϵ₁μ₁<0.

10. The method of claim 9, wherein absorbing the optical waves by the first arm and the second arm comprises absorbing the optical waves by a top surface of each of the first arm and the second arm, the top surface exposed to the optical waves and comprising a two-dimensional shape enclosed within a boundary and encompassing all of a respective space within the boundary, the boundary comprising:
a first straight line;
a second straight line perpendicular to the first straight line, a first end of the second straight line coinciding with a first end of the first straight line;
a third straight line parallel with and equal in length to the second straight line, a first end of the third straight line coinciding with a second end of the first straight line;
a first curved line comprising a first circular arc, a concave side of the first circular arc facing the second straight line, a first end of the first curved line coinciding with a second end of the second straight line and a second end of the first curved line located in a middle of a distance between the second straight line and the third straight line; and
a second curved line comprising a second circular arc, a concave side of the second circular arc facing the third straight line, a first end of the second curved line coinciding with a second end of the third straight line and a second end of the second curved line coinciding with the second end of the first curved line.

11. The method of claim 9, further comprising forming the first arm and the second arm from a conductive material.

12. The method of claim 11, wherein forming the first arm and the second arm from the conductive material comprises forming the first arm and the second arm from gold.
